(19) United States
(12) Patent Application Publication
(10) Pub. No.: US 2015/0337802 A1
(43) Pub. Date: Nov. 26, 2015

(54) SYSTEM AND METHOD FOR PITCH FAULT DETECTION

(71) Applicant: General Electric Company, Schenectady, NY (US)

(72) Inventors: Ming Su, Shanghai (CN); Jeffrey Alan Melius, Salem, VA (US); Pranav Agarwal, Niskayuna, NY (US); Mark Edward Cardinal, Schenectady, NY (US)

(21) Appl. No.: 14/712,433

(22) Filed: May 14, 2015

(30) Foreign Application Priority Data
May 26, 2014 (CN) 201410225566.4

(51) Int. Cl. F03D 7/02

(52) U.S. Cl. CPC F03D 7/0224

(57) ABSTRACT

The system includes at least one blade, a pitch command generator, a blade pitch system, a model store unit and a monitor unit. The pitch command generator is for generating at least one pitch command. The blade pitch system is for adjusting a pitch angle of the blade according to the pitch command and outputting an actual response representing an actual pitch condition of the blade in response to the pitch command. The model store unit is for receiving the pitch command and generating a desired response representing a desired pitch condition in response to the pitch command based on a nonlinear blade model. The monitor unit is for comparing a difference between the actual response and the desired response with a predetermined threshold and determining an operation status of the blade based at least in part on the difference. A method and a wind turbine are also provided.

### BACKGROUND

This disclosure generally relates to systems and methods for detecting a pitch fault of a wind turbine blade.

A wind turbine includes a blade pitch system for adjusting the blade pitch angle to keep the speed of the wind turbine rotor within operating limits as the wind speed changes. The blades are usually feathered to reduce unwanted rotational torque in the event of wind gusts or emergency shutdowns.

However, a blade runaway fault may happen when a communication error or loss happens between the turbine's system controller and the blade pitch system. Under this circumstance, the blade fault may not be controlled by the blade pitch system, and the blade may move towards either a fine position or a feather position at a high pitch rate. When all blades run away to the fine position, blades are subject to high thrust. Consequently, blade root bending moment and blade tip deflection may increase substantially. When there is one blade running away to the fine position, in addition to the increase of blade root bending moment and tip deflection of the faulty blade, imbalance loads on the hub can arise as well due to the pitch asymmetry between the faulty blade and the other blades. When there is one blade running away to the feather position, imbalance loads on the hub can arise. If the runaway fault lasts too long, it can cause damage to the blades.

It is desired that a fast and accurate detection of the pitch faults can be achieved. Faster detection of the blade fault/s can lead to earlier assignment of appropriate actions to both the faulted and other blades to constrain the induced loads.

Therefore, it is desirable to provide systems and methods to address at least one of the above-mentioned problems.

### BRIEF DESCRIPTION

In accordance with an embodiment of the invention, a system is provided. The system includes at least one blade, a pitch command generator, a blade pitch system, a model store unit and a monitor unit. The pitch command generator is for generating at least one pitch command. The blade pitch system is for adjusting a pitch angle of the blade according to the pitch command and outputting an actual response representing an actual pitch condition of the blade in response to the pitch command. The model store unit is for receiving the pitch command and generating a desired response representing a desired pitch condition in response to the pitch command based on a nonlinear blade model. The monitor unit is for comparing a difference between the actual response and the desired response with a predetermined threshold and determining an operation status of the blade based at least in part on the difference.

In accordance with another embodiment of the invention, a method for monitoring an operation status of a blade of a wind turbine is provided. The method includes generating at least one pitch command. The method includes outputting an actual response representing an actual pitch condition obtained in response to the pitch command. The method includes outputting a desired response representing a desired pitch condition obtained in response to the pitch command based on a nonlinear blade model. The method includes calculating a difference between the actual response and the desired response. The method includes comparing the difference with a predetermined threshold. The method includes determining an operation status of a blade based at least in part on the difference.

In accordance with another embodiment of the invention, a wind turbine is provided. The wind turbine includes a plurality of blades and a pitch control system. The pitch control system is for controlling a pitch angle of each of the plurality of blades. The pitch control system includes at least one blade, a pitch command generator, a blade pitch system, a model store unit and a monitor unit. The pitch command generator is for generating at least one pitch command. The blade pitch system is for adjusting a pitch angle of the blade according to the pitch command and outputting an actual response representing an actual pitch condition of the blade in response to the pitch command. The model store unit for receiving the pitch command and generating a desired response representing a desired pitch condition in response to the pitch command based on a nonlinear blade model. The monitor unit is for comparing a difference between the actual response and the desired response with a predetermined threshold and determining an operation status of the blade. When the difference exceeds the predetermined threshold and keeps an increased trend within a predetermined period, the blade is determined to be at a fault status.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of a wind turbine in accordance with one exemplary embodiment;

FIG. 2 is a block diagram of a pitch control system of the wind turbine of FIG. 1 in accordance with one exemplary embodiment;

FIG. 3 is a block diagram of a blade pitch module of FIG. 2 for controlling a corresponding blade of FIG. 1 in accordance with one exemplary embodiment;

FIG. 4 is a block diagram of a monitor unit of FIG. 2 in accordance with one exemplary embodiment;

FIG. 5 is a curve chart of showing a desired pitch condition curve and two actual pitch condition curves of a blade of FIG. 1 in accordance with one exemplary embodiment;

FIG. 6 is a curve chart of showing a difference curve between the desired pitch condition curve and one actual pitch condition curve of FIG. 5 and a predetermined threshold line in accordance with one exemplary embodiment;

FIG. 7 is a simulation view of difference points between actual responses and desired responses of a blade under different pitch angles in accordance with one exemplary embodiment;

FIG. 8 is a curve chart of showing a difference curve between the desired pitch condition curve and one actual pitch condition curve of FIG. 5 and a predetermined threshold polyline with different values under different pitch angle ranges in accordance with another exemplary embodiment; and

FIG. 9 is a flowchart of a method for monitoring an operation status of a blade of a wind turbine in accordance with one exemplary embodiment.

### DETAILED DESCRIPTION

In the following description, well-known functions or constructions are not described in detail to avoid obscuring the disclosure in unnecessary detail.

One or more specific embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either or all of the listed items. The use of “including,” “comprising” or “having” and variations thereof herein are meant to encompass the items listed thereafter and equivalents thereof as well as additional items.

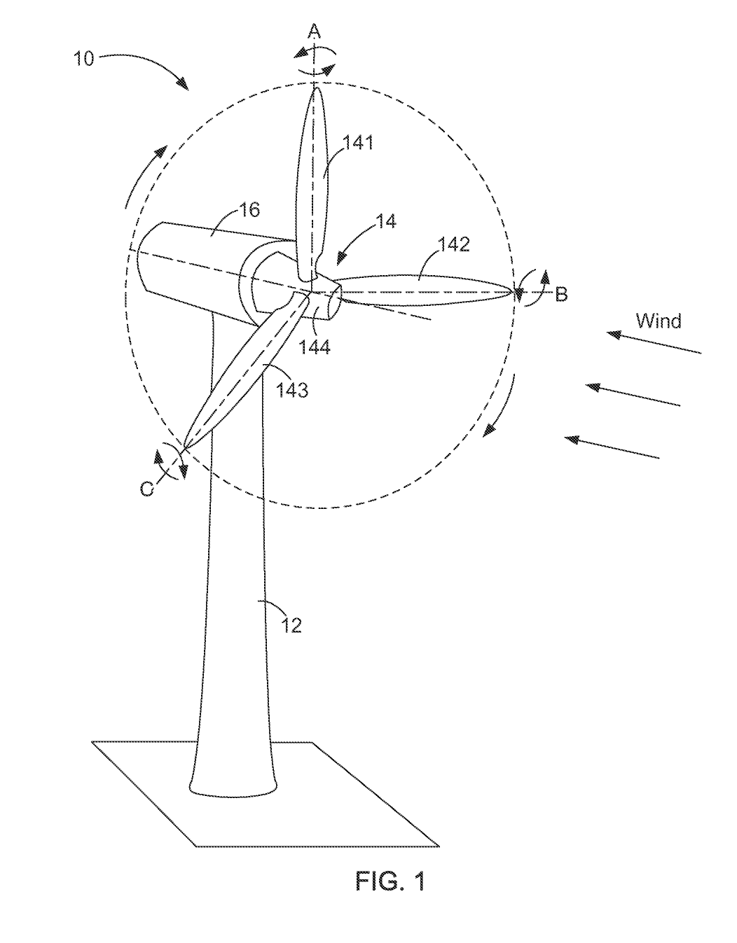

Referring now to FIG. 1, a schematic view of an exemplary wind turbine 10 in accordance with one exemplary embodiment is shown. The wind turbine 10 may include a tower section 12 and a wind turbine rotor 14. The wind turbine rotor 14 may include some blades such as three blades 141, 142 and 143 connected to a hub 144. The three blades 141, 142 and 143 receive the wind and rotate together with the wind turbine rotor 14. The wind turbine rotor 14 may convert that wind energy to a mechanical energy through a mechanism such as a gear box situated within a nacelle 16.

The nacelle 16 may optionally include a drive train (not shown), which may connect the gear box on one end to one or more generators (not shown) on the other end. The generator(s) may generate electrical power, which may be transmitted through the tower section 12 to a power distribution panel (PDP) and a pad mount transformer (PMT) for transmission to a grid (not shown). Since it is desired to obtain a stable electrical power at the grid side while keeping generator speed within design limits, it is necessary to control a pitch angle of each of the blades 141, 142 and 143 to get a stable mechanical energy regardless of the instability of the wind.

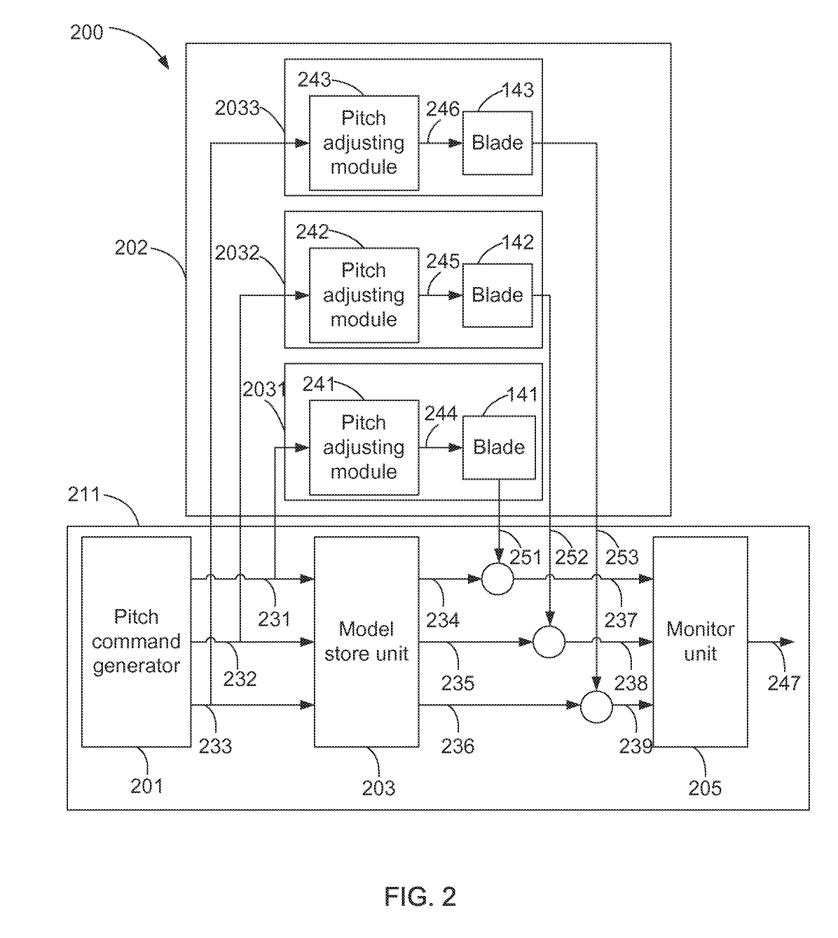

The wind turbine 10 further includes a pitch control system 200 as shown in FIG. 2 for adjusting the pitch angle of each of the blades 141, 142 and 143, schematically illustrated by the curved arrows A, B and C of FIG. 1, to keep a speed of the wind turbine rotor 14 within operating limits as the wind speed changes. More specifically, when a pitch angle of the blade (e.g., the blade 141) is changed which means the angle of the blade exposed to the wind is changed, the rotational speed of the wind turbine rotor 14 may be changed accordingly.

Referring to FIG. 2, a block diagram of the pitch control system 200 of the wind turbine 10 of FIG. 1 in accordance with one exemplary embodiment is shown. As shown in FIG. 2, the pitch control system 200 includes a pitch command generator 201, a blade pitch system 202, a model store unit 203 and a monitor unit 205.

The pitch command generator 201 is used to generate three pitch commands 231, 232 and 233 as references for the three blades 141, 142 and 143 respectively. In some embodiments, the number of the pitch commands is determined according to the number of the blades of the wind turbine 10. In some embodiments, the pitch command generator 201 is set in a system controller 211. The system controller 211 may be assembled in the tower section 12 or the nacelle 16 as shown in FIG. 1. The system controller 211 can be further used to control other operations of the wind turbine 10 such as yaw angle control and deflection control.

The system controller 211 can generate the three pitch commands 231, 232 and 233 based on the electrical power requirement of the grid and the operation state of the wind turbine 10. Each pitch command may include a pitch angle value and/or an angular velocity value for giving a reference to each blade to adjust the actual pitch angle response. More specifically, when the grid needs more electrical power, the pitch angle of each blade (e.g., the blade 141) is adjusted to move towards a fine position according to the pitch command 231 (e.g., the pitch angle of the blade 141 moves towards to a fine position such as about 5°) so as to increase a rotational torque driven by the wind. When the grid needs less electrical power or under emergency shutdowns, the pitch angle of each blade is adjusted to move towards a feather position according to the pitch command 231 (e.g., the pitch angle of the blade 141 moves towards to a feather position such as about 75°) so as to reduce the rotational torque.

The blade pitch system 202 includes three blade pitch modules 2031, 2032 and 2033 corresponding to the three blades 141, 142 and 143 respectively. As shown in FIG. 2, each blade pitch module includes a pitch adjusting module and a blade (e.g., the blade pitch module 2031 includes a pitch adjusting module 241 and the blade 141, the blade pitch module 2032 includes a pitch adjusting module 242 and the blade 142, and the blade pitch module 2033 includes a pitch adjusting module 243 and the blade 143). The three blade pitch modules 2031, 2032 and 2033 are the same in construction and function. Therefore, the blade pitch module 2031 will be taken for an example and described in detail as below.

In the blade pitch module 2031, the pitch adjusting module 241 is coupled with the corresponding blade 141 for adjusting a pitch angle of the blade 141 according to the corresponding pitch command 231. More specifically, the pitch adjusting module 241 is used to receive the pitch command 231 and generate a mechanical force 244 for adjusting the pitch angle of the blade 141. Then an actual response 251 representing an actual pitch condition of the blade 141 in response to the pitch command 231 is obtained. When the pitch command 231 is a pitch angle value, the actual response 251 is an actual pitch angle of the blade 141. When the pitch command 231 is an angular velocity value, the actual response 251 is an actual angular velocity of the blade 141.

Similarly, in the blade pitch module 2032, the pitch adjusting module 242 is used to receive the pitch command 232 and generate a mechanical force 245 for adjusting the pitch angle of the blade 142. Then an actual response 252 representing an actual pitch condition of the blade 142 in response to the pitch command 232 is obtained. In the blade pitch module 2033, the pitch adjusting module 243 is used to receive the pitch command 233 and generate a mechanical force 246 for adjusting the pitch angle of the blade 143. Then an actual response 253 representing an actual pitch condition of the blade 143 in response to the pitch command 233 is obtained.

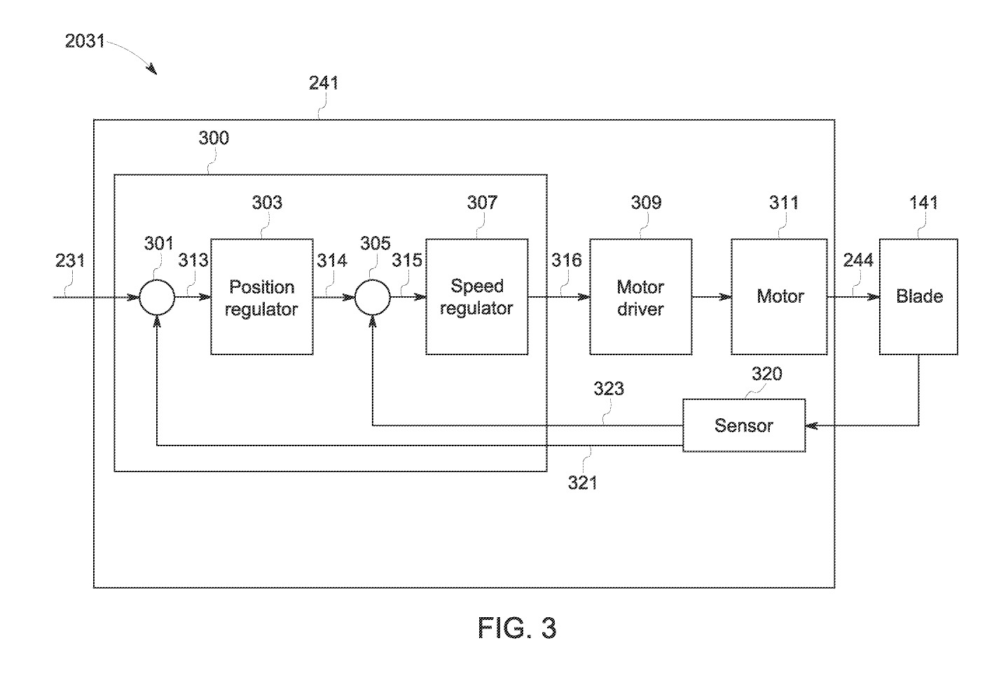

Referring to FIG. 3, a block diagram of the blade pitch module 2031 of FIG. 2 for controlling the blade 141 of FIG. 1 in accordance with one exemplary embodiment is shown. The pitch adjusting module 241 includes a pitch adjusting unit 300, a motor driver 309 and a motor 311.

The pitch adjusting unit 300 is used to implement a control algorithm. In this embodiment, the control algorithm includes a position close-loop and a speed close-loop when the pitch command 231 is a pitch angle value. In other embodiments, the control algorithm may include other algorithms such as only one position close-loop.

The position close-loop includes a first differentiator 301 and a position regulator 303. A first difference signal 313 is generated by a subtraction of the pitch command 231 and a feedback pitch angle signal 321 of the blade 141 sensed by a sensor 320. The sensor 320 may include an optical encoder for example. The sensor 320 may be attached to different positions of the blade 141 so as to obtain different signals such as the pitch angle signal 321 and an angular velocity signal 323. Then the first difference signal 313 is sent to the position regulator 303 for outputting a speed command 314 for providing to the speed close-loop. The position regulator 303 may include a proportion-integration (PI) algorithm. The position regulator 303 may include other regulating algorithms such as an intelligent control algorithm.

The speed close-loop includes a second differentiator 305 and a speed regulator 307. A second difference signal 315 is generated by a subtraction of the speed command 314 and the feedback angular velocity signal 323 of the blade 141 sensed by the sensor 320. Then the second difference signal 315 is sent to the speed regulator 307 for outputting switching signals 316 to the motor driver 309. The speed regulator 307 may include a Pulse-Width Modulation (PWM) algorithm.

In this embodiment, the motor driver 309 may include a converter with at least one switching element. The at least one switching element is used to receive the switching signals 316 and drive the motor 311. Then the motor 311 can output the mechanical force 244. Eventually, the pitch angle of the blade 141 can be adjusted with the action of the mechanical force 244.

Referring back to FIG. 2, in some embodiments, the model store unit 203 is situated within the system controller 211. In some embodiments, the model store unit 203 is situated within the blade pitch system 202. The model store unit 243 is used to store a blade model. The blade model has the same characteristics of the blade 141, 142 or 143. In one example the blade model is a nonlinear blade model. The nonlinear blade model takes into account pitch dynamics and nonlinear constraints such as the pitch velocity and the pitch acceleration to provide better pitch behavior prediction. In some embodiments, the nonlinear blade model can be constructed according to the following equations.

θ(t)=θ₀+∫ₜ₀^{t}w(t)dt (1)

w(t)=w₀+∫ₜ₀^{t}a(t)dt (2)

|w(t)|≦wₘₐₓ (3)

|a(t)|≦aₘₐₓ (4)

Wherein θ₀ refers to as an initial pitch angle of the blade 141. w(t) refers to as an angular velocity of the rotation of the blade 141. w₀ refers to an initial angular velocity of the rotation of the blade 141. a(t) refers to as an angular acceleration of the rotation of the blade 141. In this blade model, as shown in equations (3) and (4), an absolute value of w(t) is no higher than wₘₐₓ and an absolute value of a(t) is no higher than aₘₐₓ. wₘₐₓ and aₘₐₓ can be determined by an upper limit of the rotation speed and the current flowed in the motor 311 as shown in FIG. 3. In some embodiments, wₘₐₓ and aₘₐₓ can be fixed for one type of motor 311. In some embodiments, wₘₐₓ and aₘₐₓ are variable with the change of time or other changes of the characteristics of the motor 311. With the limitation of wₘₐₓ and aₘₐₓ, it can be seen that the blade model is a nonlinear model.

The model store unit 203 is further used to receive the pitch commands 231 232 and 233 and output corresponding desired responses 234, 235 and 236 respectively. Each desired response represents a desired pitch condition obtained in response to the corresponding pitch command (e.g., the desired response 234 represents a desired pitch condition of the blade 141 in response to the pitch command 231, the desired response 235 represents a desired pitch condition of the blade 142 in response to the pitch command 232, and the desired response 236 represents a desired pitch condition of the blade 143 in response to the pitch command 233). Since the nonlinear blade model stored in the model store unit 203 is more accurate than a linear blade model, more accurate desired responses 234, 235, 236 can be obtained.

The monitor unit 205 is used to monitor an operation status of a blade (e.g., the blade 141) based on the corresponding actual response (e.g., the actual pitch condition 251 of the blade 141) and the corresponding desired response (e.g., the desired pitch condition 234 of the blade 141) and, when appropriate, generate at least one fault alarm signal 247. More specifically, a difference 237 is generated by a subtraction of the actual response 251 and the desired response 234 of the blade 141 and sent to the monitor unit 205. In some embodiments, the difference 237 is further processed with an absolute value algorithm so that the difference 237 is no less than zero. Similarly, a difference 238 is generated by a subtraction of the actual response 252 and the desired response 235 of the blade 142 and sent to the monitor unit 205. A difference 239 is generated by a subtraction of the actual response 253 and the desired response 236 of the blade 143 and sent to the monitor unit 205.

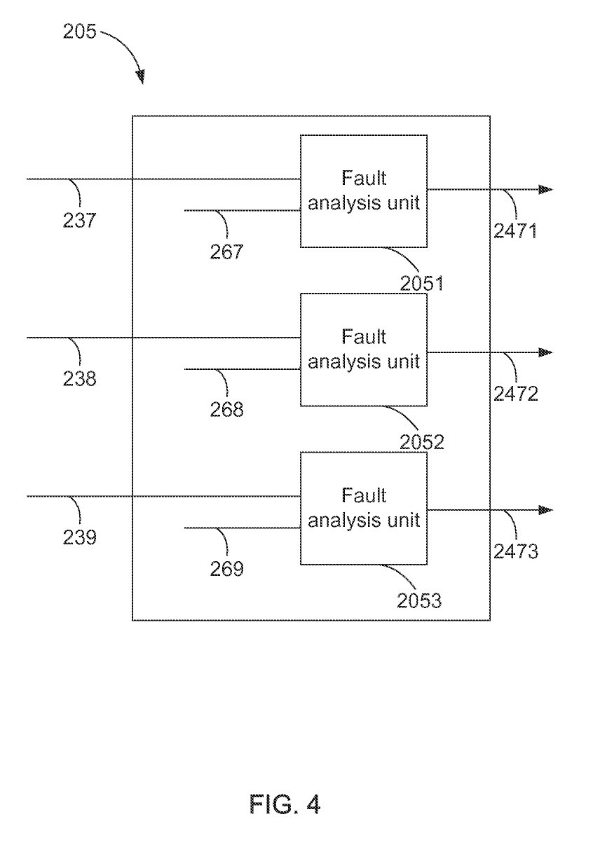

Referring to FIG. 4, a block diagram of a monitor unit 205 of FIG. 2 in accordance with one exemplary embodiment is shown. For monitoring each blade, the monitor unit 205 includes a fault analysis unit (e.g., a fault analysis unit 2051 is used to monitor the blade 141, a fault analysis unit 2051 is used to monitor the blade 142, and a fault analysis unit 2053 is used to monitor the blade 143).

In some embodiments, the monitor unit 205 is situated within the system controller 211. In some embodiments, the monitor unit 205, more specifically, the three fault analysis units 2051, 2052 and 2053 are situated within each corresponding blade pitch modules 2031, 2032 and 2033 of the blade pitch system 202 as shown in FIG. 2 respectively.

The fault analysis unit 2051 is used to compare the difference 237 between the actual response 251 and the desired response 234 of the blade 141 with a predetermined threshold 267. Similarly, the fault analysis unit 2052 is used to compare the difference 238 between the actual response 252 and the desired response 235 of the blade 142 with a predetermined threshold 268. The fault analysis unit 2053 is used to compare the difference 239 between the actual response 253 and the desired response 236 of the blade 143 with a predetermined threshold 269.

In this embodiment, using the nonlinear blade model can help minimize the model uncertainty in the pitch response so as to reduce the difference 237 between the actual response 251 and the desired response 234 for the blade 141 during the wind turbine operation. Therefore, reducing the predetermined threshold 267 is allowed. A comparison of the difference 237 with a lower predetermined threshold 267 can help decrease the fault detection time.

The three fault analysis units 2051, 2052 and 2053 may be the same in construction and function. Therefore, the fault analysis unit 2051 will be taken for an example and described in detail as below.

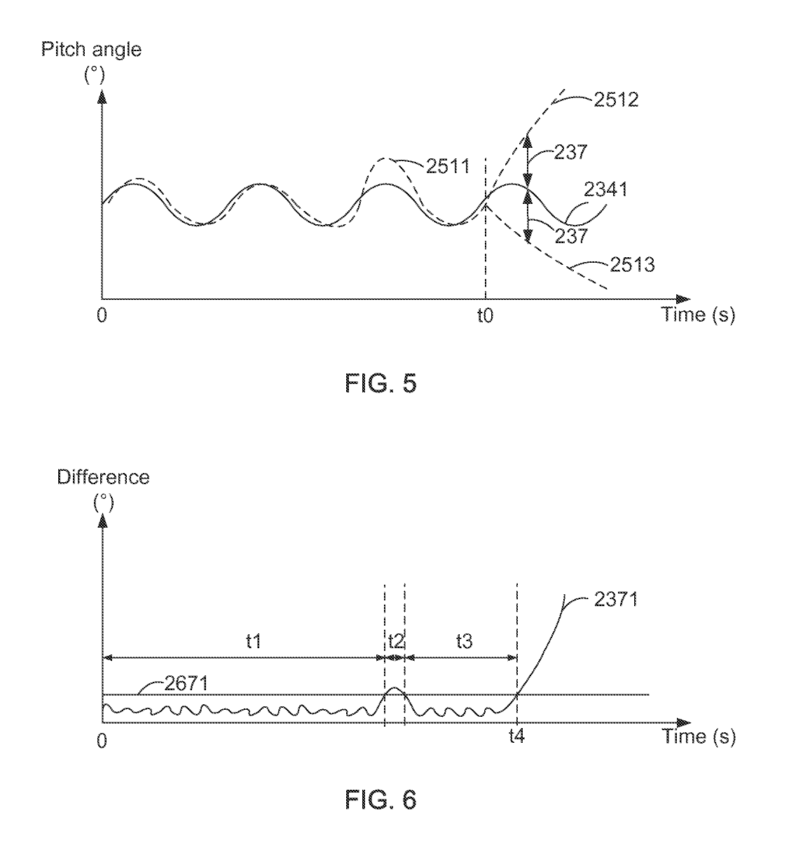

Referring to FIG. 5, a curve chart of a desired pitch condition curve 2341 and two actual pitch condition curves 2512 and 2513 of a blade of FIG. 1 in accordance with one exemplary embodiment is shown. When monitoring the blade 141, the curves 2512 or 2513 represents the actual responses 251 and the curve 2341 represents the desired response 234. From 0 to a time point t0, the two curves 2512 and 2513 are overlapped as shown a curve 2511, and after the time point t0 as shown in FIG. 5, the curve 2512 represents that the blade 141 moves towards the feather position and the curve 2513 represents that the blade 141 moves towards the fine position.

Referring to FIG. 6, a curve chart of showing a difference curve 2371 between the desired pitch condition curve 2341 and the actual pitch condition curve 2512 (or 2513) of FIG. 5 and a predetermined threshold line 2671 in accordance with one exemplary embodiment is shown. The curve 2371 represents the difference 237 between the actual response 251 and the desired response 234. It can be seen that the difference curve 2371 starts to rise quickly after the time point t0 as shown in FIG. 5 either when the corresponding blade moves towards the feather position and or fine position.

The predetermined threshold line 2671 represents the predetermined threshold 267. In some embodiments, the predetermined threshold 267 can be set as a fixed value when the pitch command 231 as shown in FIG. 2 is within a range. During a period such as t1 or t3, the difference curve 2371 is lower than the predetermined threshold line 2671 and the blade 141 is determined to work at a normal status.

During a period t2, the difference curve 2371 temporarily exceeds the predetermined threshold line 2671 and the blade 141 is determined to work at a normal status. Herein “temporarily” refers to as within a predetermined period such as less than 200 ms, the difference curve 2371 firstly exceeds the predetermined threshold line 2671 and then falls down below the predetermined threshold line 2671 quickly. Under this circumstance, due to the instability of the wind, the difference 237 rises quickly and falls quickly such that there is no need to alert the system controller 211.

The blade 141 may be falsely recognized as runaway without considering the temporarily deviation around the period t2, which may result in undesired turbine shut down. In some embodiments, raising the predetermined threshold 267 high enough can help avoid it which in turn increases the fault detection time. Therefore, in this embodiment, the temporarily deviation illustrated above can be used to determine the operation status of the blade 141 more accurate and decrease the fault detection time with a lower predetermined threshold 267.

After a time point t4, the difference curve 2371 exceeds the predetermined threshold line 2671 and keeps an increased trend, the blade 141 is determined to be at a fault status. Under this circumstance, a runaway fault may happen such as the blade 141 is not controlled by the system controller 211. Herein “an increased trend” refers to as an increase in the value of the difference 237. That is, within the predetermined period such as 500 ms, the value of the difference 237 in the subsequent sample time is larger than the previous sample time in most situations. Then the fault analysis unit 2051 as shown in FIG. 4 is used to generate a fault alarm signal 2471 when the blade 141 is determined to be at the fault status. Similarly, the fault analysis unit 2052 is used to generate a fault alarm signal 2472 when the blade 142 is determined to be at the fault status. The fault analysis unit 2053 is used to generate a fault alarm signal 2473 when the blade 143 is determined to be at the fault status.

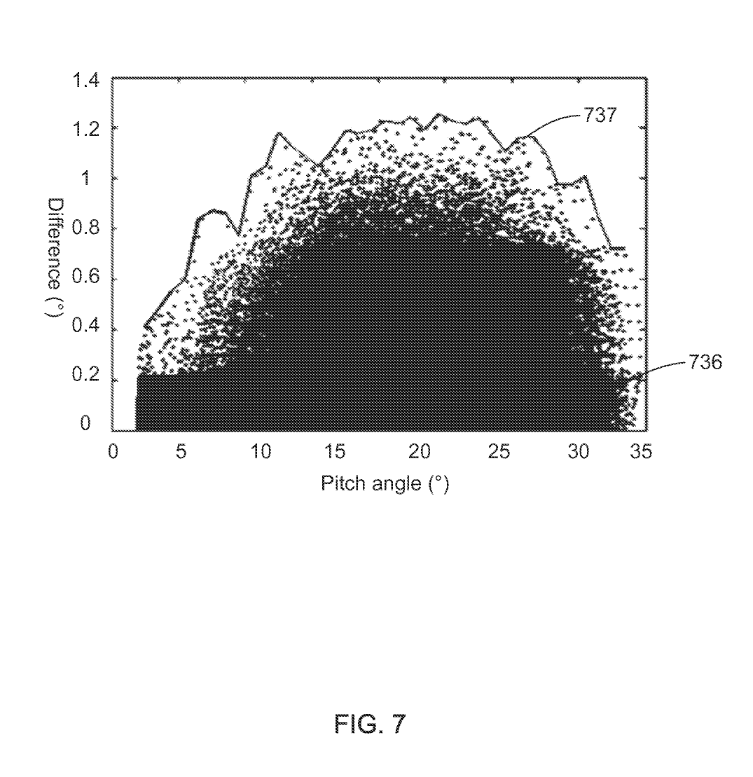

Referring to FIG. 7, a simulation view of difference points 736 between the actual response (such as 251) and the desired response (such as 234) of a blade (such as 141) under different pitch angles in accordance with one exemplary embodiment is shown. The difference points 736 represent the difference 237 between the actual response 251 and the desired response 234 of the blade 141 under a pitch angle range of 0° to 35°. In some embodiments, the difference points 736 can be obtained by simulation. In some embodiments, the difference points 736 can be collected from the blade of the real wind turbine under some test experiments or the normal operation experiments.

A curve 737 represents an envelope curve of the difference points 736. It can be seen that during different pitch angle ranges, the upper limits of the difference 237 are different. For example, the upper limit of the difference 237 is 0.6° during pitch angle range (0°, 5°), the upper limit of the difference 237 is 1.2° during pitch angle range (5°, 30°) and the upper limit of the difference 237 is 0.8° during pitch angle range (30°, 35°). Therefore, in order to detect the pitch fault quickly, the predetermined threshold line 2671 can be set with different values in response to different pitch angle ranges based on these simulated or experimented difference points 736.

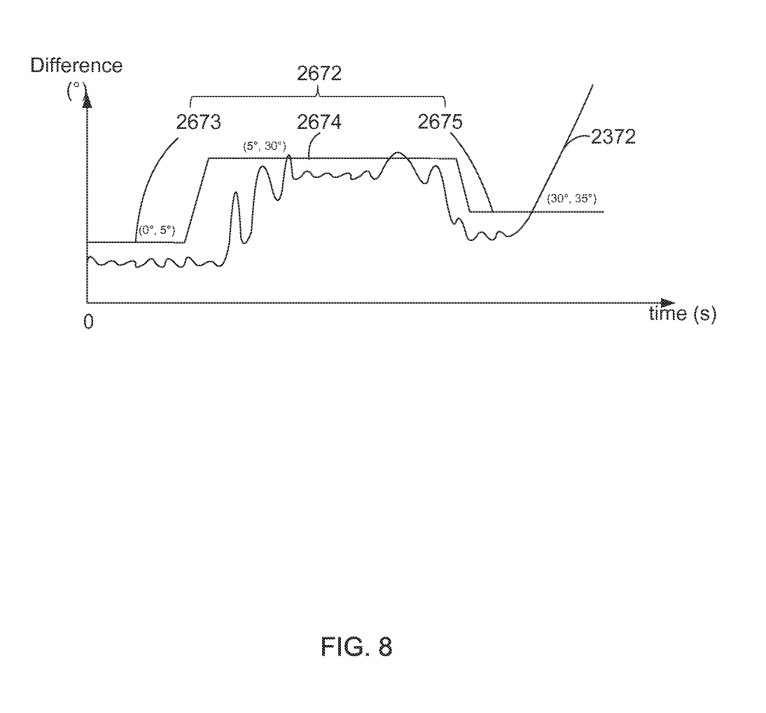

Referring to FIG. 8, a curve chart of showing a difference curve 2372 between the desired pitch condition curve and one actual pitch condition curve of FIG. 5 and a predetermined threshold polyline 2672 with different values under different pitch angle ranges in accordance with another exemplary embodiment is shown. A first section 2673 represents a first value of the predetermined threshold 267 during pitch angle range (0°, 5°), a second section curve 2674 represents a second value of the predetermined threshold 267 during pitch angle range (5°, 30°), and a third section 2674 represents a third value of the predetermined threshold 267 during pitch angle range (30°, 35°). Since the predetermined threshold 267 is set according to the experiment result or the simulation result, the predetermined threshold 267 is closer to the difference 237. During the comparison process, when the difference 237 exceeds the predetermined threshold 237 and keeps an increase trend, the pitch fault can be detected more quickly.

Referring back to FIG. 2, after at least one of the blades 141, 142 and 143 is determined to be at the fault status, the monitor unit 205 is used to generate at least one fault alarm signal 247 (e.g., at least one of the fault alarm signals 2471, 2472 and 2473). Faster detection of the pitch faults enables the system controller 211 to respond earlier to either shut down the wind turbine or take corrective actions to mitigate loads.

In some embodiments, after receiving the fault alarm signal 247, the blades 141, 142 and 143 are controlled according to a predetermined pitch command. The predetermined pitch command, in one example, may comprise be a shut-down command to control the corresponding blade to move towards to the feather position for stopping the rotation of the plurality of blades 141, 142 and 143.

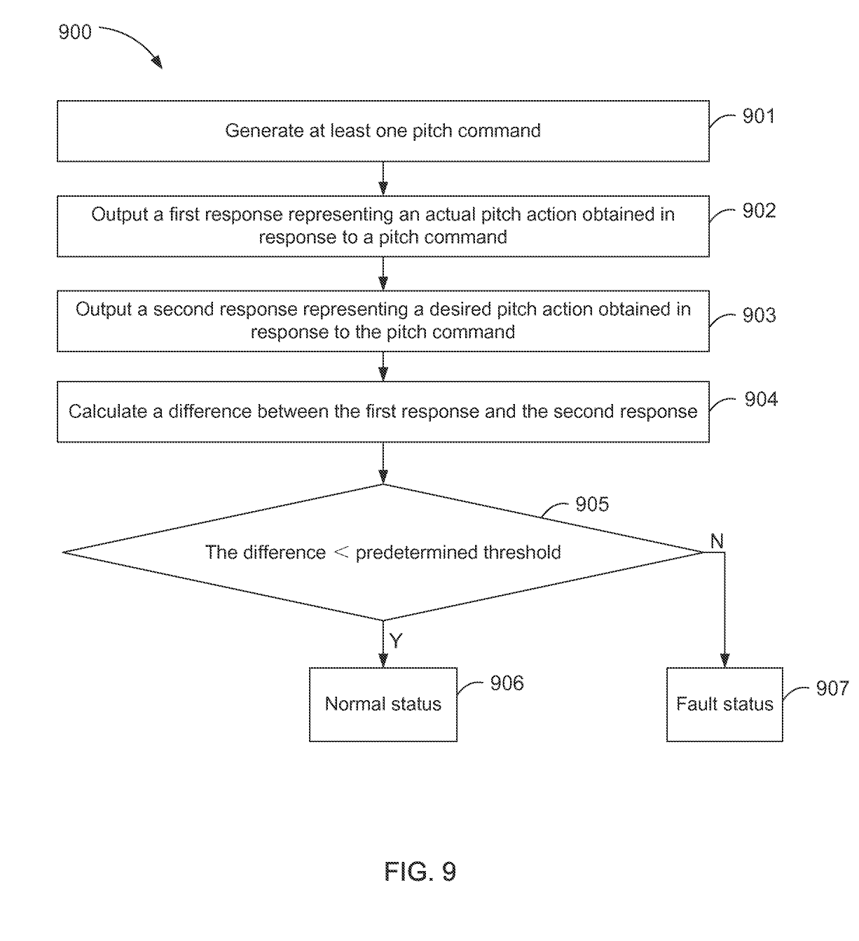

Referring to FIG. 9, a flowchart is provided of a method for monitoring an operation status of a blade of a wind turbine in accordance with one exemplary embodiment. The method 900 includes the following steps.

At block 901, at least one pitch command 231, 232 and 233 is generated.

At block 902, an actual response 251 representing an actual pitch condition obtained in response to a pitch command 231 is output.

At block 903, a desired response 234 is generated representing a desired pitch condition obtained in response to the pitch command 231 based on a predetermined nonlinear blade model.

At block 904, a difference 237 between the actual response 251 and the desired response 234 is calculated.

At block 905, the difference 237 is compared with a predetermined threshold 267. Then an operation status of a blade 141 is determined based on the comparison result.

At block 906, if the difference 237 is lower than the predetermined threshold 267 or temporarily exceeds the predetermined threshold 267 within a predetermined period, the blade 141 is determined to be at a normal status.

At block 907, if the difference 237 exceeds the predetermined threshold 267 and keeps an increased trend within the predetermined period, the blade 141 is determined to be at a fault status.

The details of the above steps have been described in detail before, so the detailed description is omitted here.

Further, as will be understood by those familiar with the art, the present invention may be embodied in other specific forms without depending from the spirit or essential characteristics thereof. Accordingly, the disclosures and descriptions herein are intended to be illustrative, but not limiting, of the scope of the invention which is set forth in the following claims.

1. A system comprising:
at least one blade;
a pitch command generator for generating at least one pitch command;
a blade pitch system for adjusting a pitch angle of the blade according to the pitch command and outputting an actual response representing an actual pitch condition of the blade in response to the pitch command;
a model store unit for receiving the pitch command and generating a desired response representing a desired pitch condition in response to the pitch command based on a nonlinear blade model; and
a monitor unit for comparing a difference between the actual response and the desired response with a predetermined threshold and determining an operation status of the blade based at least in part on the comparison result.

2. The system of claim 1, wherein the operation status of the blade comprises:
a normal status when the difference is lower than the predetermined threshold or only temporarily exceeds the predetermined threshold within a predetermined period; and
a fault status when the difference exceeds the predetermined threshold and keeps an increased trend within the predetermined period.

3. The system of claim 2, wherein, when the blade is determined to be at the fault status, the monitor unit generates a fault alarm signal.

4. The system of claim 1, wherein the nonlinear blade model is calculated based on an upper limit of an angular velocity or an upper limit of an angular acceleration of the blade.

5. The system of claim 1, wherein the predetermined threshold comprises a fixed value.

6. The system of claim 1, wherein the predetermined threshold comprises different values in response to different pitch angle ranges.

7. The system of claim 6, wherein each value of the predetermined threshold is determined according to experimented or simulated difference points under different pitch angles.

8. The system of claim 1, wherein the pitch command comprises a pitch angle value or an angular velocity value.

9. A method for monitoring an operation status of a blade of a wind turbine, comprising:
generating at least one pitch command;
outputting an actual response representing an actual pitch condition obtained in response to the pitch command;
outputting a desired response representing a desired pitch condition obtained in response to the pitch command based on a nonlinear blade model;
calculating a difference between the actual response and the desired response;
comparing the difference with a predetermined threshold; and
determining an operation status of a blade based at least in part on the comparison result.

10. The method of claim 9, wherein the operation status of the blade comprises:
a normal status when the difference is lower than the predetermined threshold or temporarily exceeds the predetermined threshold within a predetermined period; and
a fault status when the difference exceeds the predetermined threshold and keeps an increase trend within the predetermined period.

11. The method of claim 10, comprising generating a fault alarm signal when the blade is determined to be at the fault status.

12. The method of claim 11, comprising stopping the blade according to a predetermined pitch command after receiving the fault alarm signal.

13. The method of claim 9, wherein the predetermined threshold comprises a fixed value.

14. The method of claim 9, wherein the predetermined threshold comprises different values in response to different pitch angle ranges.

15. The method of claim 14, comprising determining each value of the predetermined threshold according to experimented or simulated difference points under different pitch angles.

16. A wind turbine, comprising:
a plurality of blades; and
a pitch control system for controlling a pitch angle of each of the plurality of blades, wherein the pitch control system comprises:
a pitch command generator for generating at least one pitch command;
a blade pitch system for adjusting a pitch angle of the blade according to the pitch command and outputting an actual response representing an actual pitch condition of the blade in response to the pitch command;
a model store unit for receiving the pitch command and generating a desired response representing a desired pitch condition in response to the pitch command based on a nonlinear blade model; and
a monitor unit for comparing a difference between the actual response and the desired response with a predetermined threshold and determining an operation status of the blade, wherein, when the difference exceeds the predetermined threshold and keeps an increased trend within a predetermined period, the blade is determined to be at a fault status.

17. The wind turbine of claim 16, wherein after the blade is determined to be at the fault status, the plurality of blades are controlled to stop according to a predetermined pitch command.

18. The wind turbine of claim 16, wherein the pitch command comprises a pitch angle value or an angular velocity value.

19. The wind turbine of claim 16, wherein the predetermined threshold comprises different values in response to different pitch angle ranges.

20. The wind turbine of claim 19, wherein each value of the predetermined threshold is determined according to experimented or simulated difference points under different pitch angles.
